(19) United States
(12) Patent Application Publication
(10) Pub. No.: US 2015/0344634 A1
(43) Pub. Date: Dec. 3, 2015

(54) ORGANIC-INORGANIC HYBRID PREPOLYMER, ORGANIC-INORGANIC HYBRID MATERIAL, AND ELEMENT SEALING STRUCTURE

(71) Applicants: NIHON YAMAMURA GLASS CO., LTD., Hyogo (JP); JNC CORPORATION, Tokyo (JP)

(72) Inventors: Takuya Shindo, Hyogo (JP); Midori Sato, Hyogo (JP); Kozaburo Matsumura, Tokyo (JP); Yuichi Isoda, Kumamoto (JP)

(73) Assignees: NIHON YAMAMURA GLASS CO., LTD., Hyogo (JP); JNC CORPORATION, Tokyo (JP)

(21) Appl. No.: 14/654,403

(22) PCT Filed: Dec. 19, 2013
(86) PCT No.: PCT/JP2013/084102

§ 371 Date: Jun. 19, 2015

(30) Foreign Application Priority Data
Dec. 21, 2012 (JP) 2012-280309

(51) Int. Cl. C08G 77/04; C09J 183/04

(52) U.S. Cl. CPC C08G 77/04; C09J 183/04

(57) ABSTRACT

The present invention addresses the problem of providing an organic-inorganic hybrid prepolymer, whereby synthesis can be facilitated and the hardening temperature thereof can be reduced, an organic-inorganic hybrid material obtained from said prepolymer, and an element sealing structure formed using said material. The organic-inorganic hybrid prepolymer is prepared by a condensation reaction of (A): a polydimethylsiloxane having a silanol group at a terminal end thereof, the weight-average molecular weight (Mw) thereof being 3,000-100,000, and the molecular weight distribution coefficient (Mw/Mn, where Mn is the number-average molecular weight) being 1.3 or lower; and a compound (B) which is at least one species selected from the group consisting of (B-1); a metal and/or metalloid alkoxide and/or an oligomer of the abovementioned alkoxide, (B-2); a complete or partial hydrolysate of the alkoxy group of (B-1), and (B-3); a condensation reaction product of (B-2) or (B-2) and (B-1).

### FIELD OF THE INVENTION

The present invention relates to an organic-inorganic hybrid prepolymer providing a heat resistant organic-inorganic hybrid material which can be used as a heat resistant elastic material, a sealant for a high temperature heat generating element, an adhesion layer having the high transmission property in the ultraviolet rays region or the like, and an organic-inorganic hybrid material made by using said organic-inorganic hybrid prepolymer, and an element sealing structure using said organic-inorganic hybrid material.

### BACKGROUND OF THE INVENTION

Hitherto, a heat resistant material has been used as a film, or tape for the insulating or fixing material(s) of electronic or electric parts being required heat resistance, or the like, or as a sealant for a semiconductor device and a wire bonding, or the like. A typical heat resistant material may be silicone resin. Said silicone resin has heat-resisting property wherein said silicone resin can be continuously used at a temperature between about 150° C. and about 170° C., and so said silicone resin is well-known as a low-priced elastic material having a high safety.

Recently, an organic-inorganic hybrid material, having improved properties of said silicone resin, has been developed. Said organic-inorganic hybrid is prepared by introducing an inorganic component to siloxane polymer.

Said organic-inorganic hybrid material has both the properties caused by polyorganosiloxane main structure which is organic component, such as flexibility, water repellency, release property, and the properties caused by an inorganic component such as heat resistance, thermal conductivity, or the like (for instance, see Non-Patent Document 1). Said material has excellent properties such as heat resistance and flexibility at continuous use at temperatures of 200° C. or higher, and further, a high electric insulation property, and low dielectricity at a high frequency range, and used as a sealing, or the like for light emitting element such as LED or the like (Patent Document 1˜9).

### PRIOR TECHNICAL DOCUMENTS

### Patent Documents

Patent Document 1: JPH01-113429

Patent Document 2: JPH02-182728

Patent Document 3: JPH04-227731

Patent Document 4: JP2009-292970

Patent Document 5: JP2009-164636

Patent Document 6: JP2009-024041

Patent Document 7: JP2004-128468

Patent Document 8: JP2008-69326

Patent Document 9: WO2011-125832

### NON-PATENT DOCUMENT

Non-Patent Document 1: G. Philipp and H. Schmidt, J. Non-Cryst. Solids 63,283 (1984)

### SUMMARY OF THE INVENTION

### Problems to be Solved by the Invention

As aforementioned, said organic-inorganic hybrid material has been examined to be used as the sealant for a semiconductor device, and wire bonding which are installed in the laser diode (LD), the light emitting diode (LED), the LED print head (LPH), the charge coupled device (CCD), and the insulated gate bipolar transistor (IGBT), or the like.

Up to now, the Si semiconductor has been used as a semiconductor in said electronic parts, but recently the use of SiC semiconductor and GaN semiconductor is being investigated as alternatives to said Si semiconductor. Said SiC and GaN semiconductors are expected to be used as semiconductor devices being smaller in size, and consuming less electricity, and as power elements having high efficiency, and being high frequency elements, and as semiconductor devices having excellent anti-radioactivity properties. Therefore, said SiC and GaN semiconductors are in high demand in the fields of space development and atomic energy development, as well as in the field of electricity, transportation, and consumer electrical appliances. Recently, their use as semiconductors for hybrid cars is also being investigated.

Nevertheless, most of said organic-inorganic material has very small reaction rate since said organic-inorganic material is synthesized by the dehydrated condensation reaction, and especially the polydimethylsiloxane having silanol group(s) at one end or both ends (below abbreviated as “PDMS”) contains high molecular weight component since said PDMS has a wide distribution of molecular weight and said high molecular weight component is hard to react. When the prepolymer produced by using PDMS is used as the sealant, a high reaction temperature higher than 200° C. may be required for firing (curing) so that a very long time and a very great energy are necessary as a general rule and accordingly said prepolymer has above mentioned problems.

Further in the case where said prepolymer produced by using said PDMS is used as the sealant, it is often demanded to limit the firing temperature (the reaction temperature) lower than 180° C. to reduce the heat stress to other parts. To react to said demand, it has been devised to use a metal compound such as zinc (Zn) compound, bismuth (Bi) compound, or the like as a curing agent to lighten the firing condition to lower the firing temperature (the reaction temperature). Nevertheless, in the case where said metal compound is used as s curing agent, it may be feared that said metal compound as a curing agent remains in the resulting sealant and it is feared that said metal compound cleaves the hybrid main structure by catalyzer effect of said metal compound.

Still further, in the case where said curing agent is used, it is feared that the resulting sealant can not apply for the optical material which need the high transmission of the light in the ultraviolet rays region. In addition, depending on the kind of the metal used as curing agent, it is feared to develop a color by forming a complex with the solvent which is added for stabilization.

Accordingly, in the organic-inorganic hybrid material, it is desirable to repress the use of said curing agent to be a low concentration to the utmost, and on the other hand, the demand to restrain the firing temperature (reaction temperature) as above described can not be responded enough, when the use of said curing agent is repressed.

The present invention is provided paying attention to said conventional problems and an object of the present invention is to provide a heat-resistant organic-inorganic hybrid prepolymer which is easily synthesized and can be cured at a low temperature so that said prepolymer can be used as a heat resistant elastic material, a sealant for a high temperature generating element, an adhesion layer having the high transmission property in the ultraviolet rays region or the like, and further to provide an organic-inorganic hybrid material and an element sealing structure produced by gelation of said prepolymer with heating.

### Means to Solve Said Problems

To attain said object, the present invention provides an organic-inorganic hybrid prepolymer wherein said organic-inorganic hybrid prepolymer is produced by the condensation reaction between a polydimethylsiloxane having silanol group(s) at one end or both ends and a metal and/or semimetal alkoxide and/or an oligomer of said alkoxide (includes complete or partial hydrolysate and condensate of said alkoxide and/or said oligomer) wherein said polydimethylsiloxane having silanol group(s) at one end or both ends has a weight average molecular weight (Mw) in the range of between 3,000 and 100,000 and the distribution index of molecular weight (Mw/Mn wherein Mn is number average molecular weight) is 1.3 or less (Mw/Mn≦1.3).

Further, the present invention provide an organic-inorganic hybrid material which is a gelled substance produced by gelation of said organic-inorganic hybrid prepolymer by heating.

Further, the present invention provides an element sealing structure wherein a heat generating element is sealed by using said organic-inorganic hybrid material as a sealant.

In the present specification, the weight average molecular weight (Mw) and the number average molecular weight (Mn) are respectively measured by the gel permeation chromatography (GPC) method using polystyrene as a standard substance and toluene as an eluting solvent.

More precisely, the present invention include below described matters.
[1] An organic-inorganic hybrid prepolymer produced by the condensation reaction between (A) described below and at least one compound (B) selected from the group consisting of (B-1), (B-2) and (B-3) respectively described below,
wherein
(A): a polydimethylsiloxane having silanol group(s) at one end or both ends and having a weight average molecular weight (Mw) in the range of between 3,000 and 100,000 and the distribution index of molecular weight (Mw/Mn wherein Mn is number average molecular weight) is 1.3 or less (Mw/Mn 1.3),
(B-1): metal and/or semimetal alkoxide and/or oligomer of said alkoxide

(B-2): complete hydrolysate or partial hydrolysate of (B-1) having alkoxy groups

(B-3): condensation product of (B-2) each other or (B-2) and (B-1)
[2] The organic-inorganic hybrid prepolymer described in [1], wherein said oligomer of said metal and/or semimetal alkoxide is in the range of between dimmer and decamer,

[3] The organic-inorganic hybrid prepolymer described in [1] or [2], wherein said polydimethylsiloxane having silanol group(s) at one end or both ends is a polydimethylsiloxane represented by Chemical formula (1) or Chemical formula (2).
(a) polydimethylsiloxane having silanol groups at both ends

[Chemical formula 1]

HO—Si(CH₃)₂ₗOH (1)
(b) polydimethylsiloxane having a silanol group at one end.

[Chemical formula 1]

HO—Si(CH₃)₂ₗR (2)

wherein in Chemical formula 1 and Chemical formula 2, R is an alkyl group having number of carbon 1 to 4 and l is an integer between 40 and 1351.
[4] The organic-inorganic hybrid prepolymer is accordance with any of [1] to [3], wherein said metal and/or semimetal alkoxide is represented by a general formula described below.

[Chemical formula 3]

M(OR¹)ₙR²ₘ₋ₙ (3)

wherein in said Chemical formula 3, M is a metal or a semimetal, m is valence number of M, n is an integer between 1 and m, R¹ is an alkyl group having number of carbon 1 to 4 and all R¹ may be the same or differ each other partially or wholly, R² is at least one substituent selected from the group consisting of phenyl group, vinyl group, straight chain alkyl group having number of carbon 1 to 4, and branched alkyl group having number of carbon 3 to 4 and all R² may be the same or differ each other partially or wholly.
[5] The organic-inorganic hybrid prepolymer in accordance with [4], wherein M in the above described Chemical formula 3 is at least one metal or semimetal selected from the group consisting of silicon, titanium, boron, aluminum, and niobium.
[6] The organic-inorganic hybrid prepolymer in accordance with any of [1] to [3], wherein said metal and/or semimetal oligomer is represented by formula (4).

[Chemical formula 4]

R¹OM(OR¹)ₙR²ₘ₋ₙ₋₂OₚR¹ (4)

wherein in above described Chemical formula 4, M is a metal or a semimetal, m is valence number of M, n is an integer between 0 and (m−2), p is an integer between 2 and 10, R¹ is an alkyl group having number of carbon 1 to 4 and all R¹ may be the same or differ each other partially or wholly, R² is at least one substituent selected from the group consisting of phenyl group, vinyl group, straight chain alkyl group having number of carbon 1 to 4 and branched alkyl group having number of carbon 3 to 4 and all R² may be the same or different each other partially or wholly.
[7] The organic-inorganic hybrid prepolymer in accordance with [6], wherein M in said Chemical formula 4 is at least one metal or semimetal selected from the group consisting of silicon and titanium.
[8] An organic-inorganic hybrid material which is a gelled substance produced by heating an organic-inorganic hybrid prepolymer in accordance with any of [1] to [7].
[9] The organic-inorganic hybrid material in accordance with [8], wherein the hardness of said organic-inorganic hybrid material after heating under the circumstances at 250° C. for 1000 hours is 80 or less, wherein the hardness is measured by type E durometer.

[10] An element sealing structure wherein a heat generating element is sealed using said organic-inorganic hybrid material in accordance with [8] or [9] as a sealant.

### Effects of the Invention

[Actions]

Characteristic of the present invention is to provide an organic-inorganic hybrid prepolymer produced by the condensation reaction between a polydimethylsiloxane having silanol group(s) at one end or both ends (below said polydimethylsiloxane having silanol group(s) at one end or both ends is simply described as “PDMS”) and metal and/or semimetal alkoxide and/or oligomer of said alkoxide (includes complete or partial hydrolysate and condensate of said alkoxide and/or said oligomer) wherein said PDMS is selected to have a narrowed distribution of molecular weight, to be concrete, said PDMS is selected so that the weight average molecular weight (Mw) is restricted to a designated extent and the distribution index of molecular weight (Mw/Mn) is restricted to below a designated value.

That is to say, PDMS produced by the conventional polycondensation method has a wide distribution of molecular weight and so that components having much different reactivity each other coexist in said PDMS. Said coexistence of components having much different reactivity each other results in a long time synthesis of the organic-inorganic hybrid prepolymer and further increase of low molecular weight siloxane content promotes production of insulating cyclosiloxane which is a most serious problem in silicone materials.

Accordingly, to deal with this problem, a particular PDMS is provided in the present invention. In said PDMS, the weight average molecular weight (Mw) of PDMS is controlled in designated range and the distribution index of molecular weight (Mw/Mn) is restrained below designated value in accordance with the characteristic required.

Using said PDMS, the synthesis reaction of the prepolymer can be terminated in a short time and the volatile components and the residual unreacted components can be much reduced.

Further, by narrowing down the distribution of molecular weight of PDMS which is a raw material of the prepolymer, no high molecule component is contained in the resulting prepolymer as the result, and so an useful prepolymer especially as the sealant can be provided since lowering of the reaction temperature in firing (curing) without the use of a kind of catalyzer can be realized.

[Effect]

In the present invention of the organic-inorganic prepolymer, PDMS in which the distribution of molecular weight is controlled is used as the raw material of the prepolymer, accordingly the prepolymer can be easily synthesized and further lowering of the curing temperature can be proposed.

Further, the organic-inorganic hybrid material which is the gelled substance produced from the organic-inorganic prepolymer (cured product) has a high heat-resisting property accordingly said organic-inorganic hybrid material is very useful as heat-resistant elastic material, used in sealant of high temperature heat generating element, and in adhesion layer having the high transmission property in the ultraviolet rays region or the like. Further, since element sealing structure using said organic-inorganic hybrid material as sealing material contains a small amount of volatile components and unreacted components so that said sealant may be not affected by said components, and further said organic-inorganic hybrid material can be cured at a low temperature without catalyst, accordingly said organic-inorganic hybrid material has an excellent durability concerning about the difference in temperature between functioning state and stopping state of the element (heat cycle resistance) and therefore said organic-inorganic hybrid material can provide a high temperature heat generating element having a long life and a highly efficient UV-LED element having an adhesion layer having the high transmission property in the ultraviolet rays region such as SiC, GaN semiconductor or the like.

### BRIEF DESCRIPTION OF DRAWINGS

FIG. 1 is a graph showing the spectrotransmittance.

FIG. 2 is a diagram showing measurement part of the spectrotransmittance.

FIG. 3 is a graph showing weight reduction rate with time.

FIG. 4 is a graph showing change of E-hardness (Hardness measured by using Type E durometer) with time.

### EMBODIMENTS TO PRACTICE THE INVENTION

### Definition

### Semimetal

The elements around the boundary between metallic elements and non-metallic elements in the periodic table, such as boron, silicon, germanium, arsenic, antimony, selenium, tellurium, or the like

### Weight Average Molecular Weight and Distribution Index of Molecular Weight

The weight average molecular weight (Mw) was measured by the gel permeation chromatography (GPC) method under the designated measurement condition.

The distribution index of molecular weight is an indicator of the expanse of the distribution of molecular weight and the distribution index is found by the ratio of weight average molecular weight (Mw) to number average molecular weight measured by GPC method.

In said GPC method, toluene is used as the eluting solvent and polystyrene is used as the standard substance, and the polystyrene converted molecular weight was measured.

### Organic-Inorganic Hybrid Prepolymer

The organic-inorganic hybrid prepolymer (below “organic-inorganic hybrid prepolymer” is simply abridged as “prepolymer”) is produced by the condensation reaction between polydimethylsiloxane having silanol group(s) at one end or both ends (PDMS) and metal and/or semimetal alkoxide (below “metal and/or semimetal alkoxide” is simply abridged as “alkoxide”).

When said alkoxide reacts with said PDMS, said alkoxide may be completely hydrolyzed or partially hydrolyzed or the resulting hydrolysate may be partially condensed.

Further, said alkoxide may be used as monomer or oligomer in which 2 to 10 alkoxide monomers bind together by polycondensation reaction. Said oligomer may be also hydrolyzed partially or wholly and the resulting hydrolysate may be partially condensed.

Raw materials used in prepolymer of the present invention is explained below.

### Polydimethylsiloxane Having Silanol Group(s) at One End or Both Ends (PDMS)

In the present invention, polydimethylsiloxane having silanol group(s) at one end or both ends (PDMS) is used. Said PDMS used in the present invention has narrowed molecular weight distribution.

Said PDMS has silanol group(s) at one end or both ends of polydimethylsiloxane, and said silanol group(s) can react with metal and/or semimetal alkoxide and/or oligomer of said alkoxide. In addition, said metal and/or semimetal alkoxide and/or oligomer include(s) complete hydrolysate or partial hydrolysate or condensate of said alkoxide and/or said oligomer. Said PDMS is concretely indicated the following general formula.
(a) Polydimethylsiloxane having silanol groups at both ends.

[Chemical formula 1]

HO—Si(CH₃)₂ₗOH (1)
(b) Polydimethylsiloxane having a silanol group at one end.

[Chemical formula 2]

HO—Si(CH₃)₂ₗR (2)

Wherein in Chemical formula (1) and formula (2), R is an alkyl group having number of carbon 1 to 4 (—CH₃ to —C₄H₉) and l is an integer between 40 and 1351.

Said PDMS having narrowed molecular weight distribution in the present invention has controlled weight average molecular weight (Mw) in the range of between 3,000 and 100,000 and limited distribution index of molecular weight (Mw/Mn) 1.3 or less (Mw/Mu≦1.3).

In the case where the weight average molecular weight (Mw) is 3,000 or more, it may be possible to attempt decreasing the quality of components evaporating during firing (curing) of said prepolymer and to prevent shrinkage during curing, and so PDMS having a weight average molecular weight 3,000 or more is useful for sealant or the like which need firing.

In the case where the weight average molecular weight (Mw) 100,000 or less, a high viscosity of said PDMS can be avoided so it may be not necessary to dilute high viscosity PDMS by a proper solvent, as the result, shrinkage of said prepolymer by volatilization of the solvent during firing (curing) can be solved so that said PDMS is advantageously used for sealant etc. which need firing. The weight average molecular weight (Mw) of said PDMS is more preferably in the range of between 5,000 and 50,000.

The distribution index of molecular weight (Mw/Mn) above described in the ratio of weight average molecular weight (Mw) to number average molecular weight (Mn) and for instance, in the case where all molecules contained in PDMS have the same molecular weight, the distribution index of molecular weight (Mw/Mn) becomes 1, accordingly nearer value of the distribution index of molecular weight (Mw/Mn) to 1 means more uniform molecular weight in PDMS.

In the present invention, it is necessary that the distribution index of molecular weight (Mw/Mn) is 1.3 or less (Mw/Mn≦1.3), preferably 1.2 or less (Mw/Mn≦1.2), more preferably 1.1 or less (Mw/Mn≦1.1).

As above described, said PDMS having a controlled weight average molecular weight (Mw) and a narrowed molecular weight distribution by limiting the distribution index of molecular weight (Mw/Mn) can be produced by various method and PDMS having the molecular weight distribution as specified in the design can be produced by the living anion polymerization using alkyl lithium as an initiator.

### Metal and/or Semimetal Alkoxide

Said metal and/or semimetal alkoxide has (have) the following general formula.

[Chemical formula 3]

M(OR¹)ₙR²ₘ₋ₙ (3)

wherein in said formula (3), M is a metal or a semimetal, m is valence number of M, n is an integer between 1 and m, R¹ is an alkyl group having number of carbon 1 to 4 (—CH₃ to —C₄H₉) and all R¹ may be the same or differ each other partially or wholly, R² is at least one substituent selected from the group consisting of phenyl group, vinyl group, straight chain alkyl group having number of carbon 1 to 4 (—CH₃ to —C₄H₉) and branched alkyl group having number of carbon 3 to 4 and all R² may be the same or differ each other partially or wholly.

As a metal and/or semimetal of said metal and/or semimetal alkoxide to be used in the present invention, silicon, boron, aluminum, titanium, vanadium, manganese, iron, cobalt, zinc, germanium, yttrium, zirconium, niobium, lanthanum, cerium, cadmium, tantalum, tungsten, or the like is (are) illustrated. Desirable metals or semimetals may be silicon, titanium, zirconium, aluminum, boron, niobium, and further desirable metal and/or semimetal may be silicon, titanium and zirconium.

Further, the kind of said alkoxide is not particularly limited, and said alkoxide may include such as methoxide, ethoxide, n-propoxide, iso-propoxide, n-butoxide, iso-butoxide, sec-butoxide, tert-butoxide, methoxy-ethoxide, ethoxy-ethoxide or the like, and from the viewpoint of stability and safety, ethoxide, propoxide, isopropoxide, or the like are desirable alkoxides.

In above described alkoxide, silicon alkoxide is a particularly desirable alkoxide, since said silicon alkoxide is easily available, and stable in the air.

Said silicon alkoxide may include tetraalkoxysilane such as tetramethoxysilane, tetraethoxysilane, tetrapropoxysilane, tetraisopropoxysilane, tetrabutoxysilane or the like, trialkoxysilane such as methyltrimethoxysilane, methyltriethoxysilane, methyltripropoxysilane, methyltributoxysilane, ethyltrimethoxysilane, ethyltriethoxysilane, n-propyltrimethoxysilane, n-propyltriethoxysilane, isopropyltrimethoxysilane isopropyltriethoxysilane, phenyltrimethoxysilane, phenyltriethoxysilane or the like, dialkoxysilane such as dimethyldimethoxysilane, dimethyldiethoxysilane, diphenyldimethoxysilane, diphenyldiethoxysilane or the like, mono alkoxysilane such as trimethylmethoxysilane, trimethylethoxysilane or the like are illustrated. In said alkoxide, preferable alkoxide may be such as tetraethxysilane (TEOS), methyltriethoxysilane (MTES), tetrapropoxysilane, tetraisopropoxysilane, tetrabutoxysilane or the like are illustrated.

Other preferable alkoxide may be such as titanium tetraisopropoxide (TTP), titanium tetra-n-butoxide, zirconium tetrapropoxide (ZTP), zirconium tetra-n-butoxide, aluminum tri-sec-butoxide, aluminum triisopropoxide, boron triethoxide, boron tri-n-butoxide, niobium penta-n-butoxide, niobium pentaethoxide or the like are illustrated.

[Oligomer of Metal and/or Semimetal Alkoxide]

Oligomer of metal and/or semimetal alkoxide which can be used in the present invention (below “oligomer of metal and/or semimetal alkoxide” is abbreviated as “oligomer”) is low condensate and said oligomer is preferably dimmer to decamer (degree of polymerization between 2 and 10), more preferably tetramer to decamer (degree of polymerization between 4 and 10). Said oligomer has the following general formula.

[Chemical formula 4]

R¹OM(OR¹)ₙR²ₘ₋ₙ₋₂OₚR¹ (4)

wherein in above described Chemical formula 4, M is a metal and/or a semimetal, m is valence number of M, n is an integer between 0 and (m−2), p is an integer between 2 and 10, R¹ is an alkyl group having number of carbon 1 to 4 and all R¹ may be the same or differ each other partially or wholly.

R² is at least one substituent selected from the group consisting of phenyl group, vinyl group, straight chain alkyl group having number of carbon 1 to 4 (—CH₃ to —C₄H₉) and branched alkyl group having number of carbon 3 to 4 and all R² may be the same or different each other partially or wholly.

Preferable M may be silicon and titanium and most preferable M is silicon from the point of view of the reaction control.

Said oligomer has lower volatility than alkoxide monomer and lower size of functional group (alkoxy group) so that reaction rate of polycondensation of said oligomer alone is smaller than metal and/or semimetal alkoxide monomer alone, and as the result, said oligomer can react with PDMS more uniformly than alkoxide monomer.

### Production of Organic-Inorganic Hybrid Prepolymer Sol

As above described, in the present invention, prepolymer is produced by condensation reaction of said PDMS and said alkoxide and/or said oligomer (below “alkoxide and/or oligomer” is simply described as “alkoxide (oligomer)” in said description, complete or partial hydrolysate and condensate of said alkoxide (oligomer) are included).

In said condensation reaction, usually condensation catalyst is used such as organic tin compound such as dibutyltin dilaurate, dibutyltin di-2-ethylhexoate or the like, organic titanium compound such as titanium tetra-2-ethylhexoxide or the like.

In a case where said condensation reaction is carried out, in order to hydrolyze said PDMS and said alkoxide (oligomer) stably, a hydrolysis and condensation reaction are preferably carried out by heating in a reactor filled with an inert gas. Said inert gas may include nitrogen gas, and rare-gas which belongs to the group 18 elements such as helium, neon, argon, krypton, xenon, or the like. Two or more kinds of said gas may be used together.

As the method of hydrolysis, various methods such as dropping or spraying a proper quantity of water, introduction of water vapor or the like may be conceivable.

Said prepolymer is produced by condensation reaction of a mixture containing said alkoxide (oligomer) (including complete or partial hydrolysate and condensate of said alkoxide (oligomer)) and said PDMS under existence of said condensation catalyst in said inert gas atmosphere. Since said alkoxide (oligomer) is hydrolyzed under existence of water, alkoxy group of said alkoxide (oligomer) changes to silanol group having a high reactivity.

To be more precise, said hydrolyzed alkoxy group of said alkoxide changes to an —OH group at least partially, and the condensation reaction between said —OH group of the resulting hydrolyzed alkoxide and the silanol group at the end of said PDMS is carried out by heating in the presence of said inert gas. In a case where said alkoxide is provided as an oligomer, the condensation reaction of said alkoxide alone will not accelerate, so that the condensation reaction between the PDMS and the hydrolyzed oligomer can be smoothly carried out, to advance the condensation reaction favorably through the homogeneous reaction between said oligomer and said PDMS.

The hydorolysis reaction of said alkoxide (oligomer) may be apt to be effected from water contained in the atmosphere so that in the case where said condensation reaction is carried out in the atmosphere, the reaction control between said alkoxide (oligomer) and said PDMS becomes difficult. Accordingly, for stable synthesis of said organic-inorganic hybrid prepolymer by reacting said alkoxide (oligomer) and said PDMS uniformly, it may be very important that said reaction is carried out under an inert gas atmosphere controlling water content in the atmosphere strictly.

In the case of using PDMS having a large distribution index of molecular weight (Mw/Mn), concretely PDMS having the distribution index of molecular weight (Mw/Mn) more than 1.3, it may be necessary to react said alkoxide (oligomer) and said PDMS changing the reaction temperature and the water content in the inert gas atmosphere and further it is necessary to control strictly the reaction temperature and the water content in the atmosphere.

On the other hand, in the case of using the PDMS having the weight average molecular weight (Mw) of which is controlled, and having a narrow distribution of molecular weight by making the distribution index of molecular weight (Mw/Mn) small, the reaction between said alkoxide (oligomer) and said PDMS will be stable and can be completed quickly by fixing the reaction temperature and the water content in the inert gas atmosphere to secure the stability of the reaction. According to said manner, the treatment at a low temperature and in a short time can be realized since the amount of the residual siloxane polymer which is unreacted component in the prepolymer becomes small so that said residual siloxane polymer does not effect on the curing with heating said prepolymer and further the weight average molecular weight (Mw) of said PDMS is controlled accordingly no high molecular component is contained in said prepolymer.

In the case where said prepolymer is produced, a stabilizing solvent is preferably added in the raw materials solution of the mixture containing said alkoxide (oligomer) and said PDMS under the inert gas atmosphere. By addition of said stabilizing solvent to the raw materials solution, the hardening of said prepolymer is prevented and so said raw materials solution can be stored with stability, namely the pot life of said raw materials solution can be prolonged.

As said stabilizing solvent, tertially butyl alcohol (tert-butyl alcohol) is a preferable solvent and further esters such as ethyl acetate can be also used and especially in the case where the colorless product is required, use of tert-butyl alcohol is preferable solvent. Heptane, hexane, methyl ethyl ketone (MEK), methyl isobutyl ketone (MIRK) or the like, or organic solvents such as toluene, xylene or the like, or alcohols such as ethanol, isopropyl alcohol or the like (however only alcohol in which the water thoroughly removed is available) may be used as other stabilizing solvent.

[Ratio of the Combination]

Ratio of the combination between said PDMS (A) and said alkoxide (oligomer) (B-1) ((A)/(B-1)) is preferably set in the range of between 0.1 and 10, more preferably 0.5 and 5, further more preferably 0.8 and 3 in molar ratio, wherein molar ratio defined in the present invention is found by calculating based on the weight average molecular weight (Mw) of PDMS and the purity and the average molecular weight of alkoxide or oligomer thereof, wherein said weight average molecular weight (Mw) of PDMS is measured by the gel permeation chromatography (GPC) method using toluene as an eluting solvent.

In the case where molar ratio (ratio of the combination) is put in the above described extent, the condensation reaction may be smoothly carried out and the gelation during the reaction or after the reaction may be hard to take place and so the gel product is hard to be formed. Accordingly, a stable sol in which no unreacted siloxane remains can be guaranteed.

### About the Heat-Resistant Structure

### Organic-Inorganic Hybrid Material

The organic-inorganic hybrid material is composed of a gelled substance (cured substance) produced from the organic-inorganic hybrid prepolymer sol by heating. Said organic-inorganic hybrid material is used as the heat-resistant adhesive material, the heat-resistant sealing material or the thermally conductive material which has higher quality than the conventional material and it may be possible to provide a heat-resistant structure having a high quality by using said organic-inorganic hybrid material.

Further, said organic-inorganic hybrid material preferably has hardness 80 or less wherein said hardness is measured by using the type E durometer (JIS K6253) after heating under the circumstances at 250° C. for 1000 hours. And so in the case where said organic-inorganic hybrid material of the present invention is used as the sealant, the destruction phenomenon such as the crack and the abrasion or the like is hard to occur under the circumstances at a high temperature between 200° C. and 250° C. resulting from the heat generated from the semiconductor elements such as SiC, GaN or the like and as the result, no problem about the breaking of the wire bonding and the deterioration of the insulation may occur. Accordingly, the present invention can provide a semiconductor element having a high quality.

Said organic-inorganic hybrid material of the present invention may also be useful as the optical adhesive, the optical sealant. In the optical parts, the transmissivity is often regarded as important. Using said organic-inorganic hybrid material produced by using said PDMS having a narrow molecular weight distribution, very homogeneous cross-linking structure is produced after curing, and accordingly said organic-inorganic hybrid material has a high transmissivity. Because of the above described high transmissivity, said organic-inorganic hybrid material is at advantage over the common sealant in the transmissivity especially in UV wavelength range required sealing of the element whose object is fixing of the polarizing film and taking out of UV rays.

Since said organic-inorganic hybrid prepolymer can be cured at a low temperature and in a short time so that the amount of the curing catalyst can be decreased and as the result, the resulting cured organic-inorganic hybrid material can connect to the parts having a low heat-resistance property such as the polarizing film or the like accordingly the light in UV wavelength range can pass through the resulting cured organic-inorganic hybrid material.

### Sealing Structure of the Element

The sealing structure of the element of the present invention is made by sealing the element by using said organic-inorganic hybrid material as a sealant.

Said element may include an element mainly consisting of a semiconductor, or an element into which semiconductor(s) is (are) installed, or a device wherein semiconductor(s) is (are) installed on the upper side of said device's substrate. Said element (device) may include such as a transistor, diode, rectification element, negative resistance element, photovoltaic element, photoconductive element, light-emitting element, magnetoelectricity element, operation element installed in an operation unit, or the like.

For instance, in said element, which emits or receives light (all together, they are said to be an optical element), such as photovoltaic element, photoconductive element, light-emitting element, or the like, a light emitting face or a light receiving face can be covered with this sealant for protection.

Further, in the element(s) installed on the substrate, the terminal(s) of said element(s) is (are) electrically connected to the terminal(s) arranged on the surface of said substrate by wire bonding(s), and said wire bonding(s) can also be sealed together with said element(s) by said sealant.

And the sealant containing said organic-inorganic hybrid material of the present invention as the main component is applied on or casted in at least the emitting surface and/or the receiving surface of the optical element for sealing. When said sealant is applied on or casted in, it should pay attention to prevent inclusion of air bubbles into said sealant and therefore it is desirable to conduct the vacuum-defoaming treatment quickly after sealing.

After application or casting of the sealant, said element is put in the high temperature furnace (oven) to gelate said sealant to be a gelled substance in solid state or semisolid state and so the gelled sealant having a desired shape is obtained.

In the case where said prepolymer produced by using said PDMS having a narrow molecular weight distribution in the present invention is used as said sealant, said prepolymer can be cured quickly at lower temperature than the conventional temperature without additives (curing agent). Of course the curing agent may be added to lower the reaction temperature so far as not to ruin the required efficiency of said organic-inorganic hybrid material or said sealant may be cured at a temperature nearby room temperature for long time. Nevertheless, in the case where said sealant is used at a high temperature, higher than 250° C., the curing agent should not preferably be used to improve the heat-resisting property.

As said curing catalyst, at least one kind of organometallic compound such as Sn containing compound, Ti containing compound. Al containing compound, Zn containing compound, Zr containing compound, Bi containing compound or the like may be used.

Said organometallic compound may be such as metallic salt of an organic acid (especially carboxylate), alkoxide, alkylmetal compound, acetylacetonate complex, ethyl acetoacetate complex, metal complex wherein a part of alkoxy group of metal alkoxide is substituted with acetylacetonate or ethyl acetoacetate or the like, and more concretely, such as zinc octylate, zirconium octylate, dibutyltin dilaurate, dibutyltin diacetate, dibutyltin bis-acetylacetonate, tetra (2-ethylhexyl) titanate, titanium tetra n-butoxide, titanium tetraisopropoxide, titanium diisopropoxy-bis (ethyl acetoacetate), titanium tetraacetylacetonate, titanium diisopropoxy-bis (acetylacetonate), zirconium tetra n-propoxide, ziruconium tetra n-butoxide, zirconium tetraacetylacetonate, zirconium tributoxy monoacetylacetonate, zirconium dibutoxy-bis (ethyl acetoacetate) or the like are illustrated.

Further, to give a uniform structure from the surface to the inner part of said organic-inorganic hybrid material which is the cured organic-inorganic hybrid prepolymer, it is especially preferable to use both zirconium carboxylate such as zirconium octylate and zinc carboxylate such zinc octylate.

Hitherto, silicone resin, organic-inorganic hybrid material has been used as the sealant, nevertheless said conventional sealant have a fault to cause the deterioration under a high temperature higher than 200° C. depending on cleavage of silicone main structure or the like. Further, even under the usual temperature, since said conventional material may become cloudy or turn yellow caused by long-term deterioration by irradiating continuingly short wavelength light such as ultraviolet rays, change of the material characteristic has occurred in said conventional material.

Nevertheless, said sealant produced by using said organic-inorganic hybrid prepolymer can maintain continually colorless and transparence, since the hybrid structure of said sealant has a lot of inorganic bonding site, moreover the cross-linked structure becomes homogeneous by said PDMS having a narrow molecular weight distribution in comparison with conventional silicone resin and so heat deterioration and long-term deterioration of said sealant do not occur.

Further, said sealant of the present invention can maintain transparency and light transmission property even if the near ultraviolet ray is irradiated for a long time because said sealant has many inorganic bonding site namely strong inorganic bonding.

### EXAMPLES

The present invention is further concretely explained by using EXAMPLES.

Incidentally in EXAMPLES, “part”, “%” are respectively “weight part”, “weight %” unless particular explanations are carried out.

The present invention should not be limited only by below described EXAMPLES.

### Synthesis EXAMPLES of PDMS

### EXAMPLES Relating to Synthesis of PDMS Having Silanol Groups at Both Ends

PDMS having silanol groups at both sides is represented by [Chemical formula 1] and Synthesis EXAMPLES (1) to (3) relating to synthesis of said PDMS are below described.

[Chemical formula 1]

HO—Si(CH₃)₂ₗOH (1)

wherein l in said Chemical formula (1) is an integer between 40 and 1351.

### Synthesis EXAMPLE (1): FM9925 (Type No.)

[1] 400 pars by weight of hexamethylcyclotrisiloxane was dissolved in 400 parts by weight of dehydrated toluene and the resulting solution was put in a 1000 mL four-necked flask equipped with a stirrer, a sampling equipment, a thermometer with a protection tube and a silicone rubber septum.

[2] 0.83 parts by weight of water was dissolved in 20 parts by weight of DMF and the resulting solution was put into [1] in the flask under N₂ stream and the resulting solution was heated to keep at 30° C.

[3] 1 mL of hexane solution of butyllithium (1.6 mol/L) was added into the solution in [2] and the resulting mixture was reacted for polymerization for 4.5 hours. After then 0.4 parts by weight of acetic acid was added to finish the reaction.

[4] The resulting acetate of lithium was removed by washing with water and then low boiling point compound such as solvents were removed by using the evaporator. Thus, 361 parts by weight of the objective linear PDMS both ends of which were modified with silanol groups was obtained (below “linear PDMS both ends of which were modified with silanol groups” is simply described as “PDMS having silanol groups at both ends”).

[5] The weight average molecular weight and the number average molecular weight of the resulting PDMS having silanol groups at both ends were measured by the gel permeation chromatography (GPC) using polystyrene as a standard substance (polystyrene converted molecular weight) and the results are as follows. Considering the results, it was ascertained that the resulting PDMS having silanol groups at both ends had the weight average molecular weight (Mw) controlled within a designated extent and had a distribution index of molecular weight (Mw/Mn) being set below a designated value and so that said PDMS had a narrow molecular weight distribution.
Weight average molecular weight (Mw)=9,990
Number average molecular weight (Mn)=8,890
Distribution index of molecular weight (Mw/Mn)=1.12
GPC measuring conditions applied in Illustration of synthesis (1) are as follows.
a) Measurement instrument:
   JASCO Corporation ChromNAV (Data processor)
   JASCO Corporation PU-980 (pomp)
   JASCO Corporation DG-980-50 (Degasser)
   JASCO Corporation CO-2065 (Column oven)
b) Detector: JASCO Corporation RI-930 (Differential refractive index detector)
c) Column: Shodex KF-804L×2
d) Column temperature: 40° C.
e) Eluting solvent: Toluene 0.7 mL/min
f) Standard substance: Polystyrene
g) Injection amount: 20 μL
h) Concentration: Sample/solvent=2 drops/4 mL
i) Sample preparation: Use toluene as a solvent and dissolve at room temperature
j) Calibration: Before measurement, calibration curve is made by using the standard sample.

### Synthesis EXAMPLE (2) FM9926 (Type No.)

[1] The same as step [1] in [Synthesis EXAMPLE (1)]
[2] The same as step [2] in [Synthesis EXAMPLE (1)] excepting that 0.42 parts by weight of water was used.

[3] The same as step [3] in [Synthesis EXAMPLE (1)]

[4] 371 parts by weight of PDMS having silanol groups at both ends was obtained by the same manner as step [4] in [Synthesis EXAMPLE (1)]
[5] The weight average molecular weight and the number average molecular weight were found by the same way as step [5] in [Synthesis EXAMPLE (1)] (polystyrene converted molecular weight by gel-permeation chromatography (GPC) method), and the results are described as follows.

Referring to the results, it is recognized that the resulting PDMS having silanol groups at both ends had the weight average molecular weight (Mw) controlled within a designated extent and had a distribution index of molecular weight (Mw/Mn) being set below a designated value so that said PDMS had a narrow molecular weight distribution.

Weight average molecular weight (Mw)=23,000

Number average molecular weight (Mn)=20,900

Distribution index of molecular weight (Mw/Mn)=1.10

### Synthesis EXAMPLE (3): FM9927 (Type No.)

[1] The same as step [1] in [Synthesis EXAMPLE (1)]
[2] The same as step [2] in [Synthesis EXAMPLE (1)] excepting that 0.28 parts by weight of water was used.
[3] The same as step [3] in [Synthesis EXAMPLE (1)]
[4] 375 parts by weight of PDMS having silanol groups at both ends was obtained by the same manner as step [4] in [Synthesis EXAMPLE (1)]
[5] The weight average molecular weight and the number average molecular weight were found by the same way as step [5] in [Synthesis EXAMPLE (1)] (polystyrene converted molecular weight by gel permeation chromatography (GPC) method) and the results are described as follows. Referring to the results, it is recognized that the resulting PDMS having silanol groups at both ends had the weight average molecular weight (Mw) controlled within a designated extent and had a distribution index of molecular weight (Mw/Mn) being set below a designated value so that said PDMS had a narrow molecular weight distribution.

Weight average molecular weight (Mw)=32,000

Number average molecular weight (Mn)=29,400

Distribution index of molecular weight (Mw/Mn)=1.09

### Synthesis EXAMPLE Relating to Synthesis of PDMS Having a Silanol Group at One End

PDMS having a silanol group at one end represented Chemical formula 2 (FM0925 (type No.)) are described below.

[Chemical formula 2]

HO—Si(CH₃)₂ₗR (2)

wherein R is an alkyl group having number of carbon 1 to 4 (—CH₃ to —C₄H₉) and l is an integer between 40 and 1351.
[1] 400 parts by weight of hexamethylcyclotrisiloxane was dissolved in 400 parts by weight of dehydrated toluene and the resulting solution was put in a 1000 mL four necked flask equipped with a stirrer, sampling equipment, a thermometer with a protection tube and a silicone rubber septum.

[2] 30 mL of hexane solution of butyllithium (1.6 mol/L) was added to [1] in the flask under N₂ current and the resulting solution was heated to keep at 30° C. and then 20 parts by weight of DMF was added to said solution to start the polymerization.

[3] After the polymerization [2] for 3.0 hours, 3.4 parts by weight of acetic acid was added to finish the reaction.

[4] The resulting acetate of lithium was removed by washing with water and then low boiling point compound such as solvents were removed by using the evaporator. Thus 370 parts by weight of the objective linear PDMS one end of which was modified with silanol group was obtained (below “linear PDMS one end of which is modified with a silanol group” is simply described as “PDMS having a silanol group at one end”).

[5] The weight average molecular weight and the number average molecular weight of the resulting PDMS having a silanol group at one end were measured by the gel permeation chromatography (GPC) using polystyrene as a standard substance (polystyrene converted molecular weight) and the results are as follows.

Considering the results, it was ascertained that the resulting PDMS having a silanol group at one end had the weight average molecular weight (Mw) controlled within a designated extent and had a distribution index of molecular weight (Mw/Mn) being set below a designated value and so that said PDMS had a narrow molecular weight distribution.
Weight average molecular weight (Mw)=11,100
Number average molecular weight (Mn)=9,880
Distribution index of molecular weight (Mw/Mn)=1.12
GPC measuring conditions applied in Synthesis EXAMPLE (1) are the same as in Synthesis EXAMPLES (1) to (3).

### EXAMPLE 1

### Preparation of Prepolymer 1 Used as the Adhesive For UV Polarizing Film

[1] N₂ gas was used as an inert gas and said N₂ gas was filled enough in a reactor equipped with a stirrer, a thermometer, and a dropping means, water content of said N₂ gas being adjusted at constant. N₂ gas used in EXAMPLE 1 was prepared by using N₂ gas producing equipment (Japan UNIX Co., UNX-200).

[2] 80.0 gs of said PDMS having silanol groups at both ends prepared in Synthesis EXAMPLE (1) (manufactured by JNC, FM9925, weight average molecular weight (Mw)=9,990, distribution index of molecular weight (Mw/Mn)=1.12) was put into said reactor in which N₂ gas was filled enough at step [1]. After that, 17.5 gs of ethyl silicate (manufactured by Tama Chemicals Co., Ltd. Silicate 40: linear oligomer which is tetramer to hexamer, purity: 70% by mass, average molecular weight=745) was put into said reactor. Molar ratio of FM9925 to net amount of said oligomer in Silicate 40 was 1:2.

[3] After step [2], 0.03 gs of dibutyltin dilaurate was added and stirred the contents for one hour at 140±5° C. to obtain raw material solution 1.

[4] 3 gs of tert-butyl alcohol as a stabilizing solvent was dropped into the raw material solution 1 prepared in step [3] under N₂ gas atmosphere with agitation to obtain Prepolymer 1.

During said reaction, N₂ gas was always flowed into the reactor.

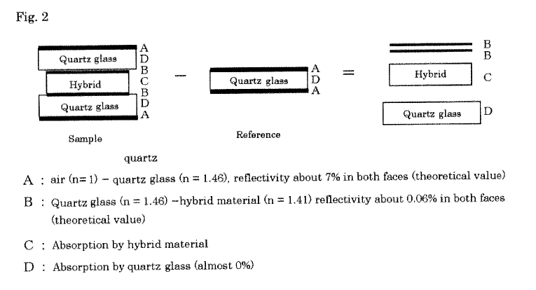

### Preparation of Sample 1 For Evaluation by Using Prepolymer 1

[A] Using two pieces of quartz glass plates having thickness 0.5 mm respectively and said two pieces of quartz glass plates were set so as to set each other keeping a space 0.5 mm by using a spacer.
[B] Said prepolymer 1 (sol state) prepared in step [4] was put between said two pieces of quartz glass plates keeping a space 0.5 mm so as to form an assembly consisting of quartz glass plate/hybrid material made from prepolymer 1/quartz glass plate. The resulting assembly was heated at 200° C. for 5 hours to cure (gelate) to obtain sample of EXAMPLE 1 as sample for evaluation 1 (cf. FIG. 2).

### EXAMPLE 2

### Preparation of Prepolymer 2 Used as the Adhesive For UV Polarizing Film

[1] Step [1] of EXAMPLE 2 was the same as step [1] of EXAMPLE 1.
[2] N₂ gas filled enough in the reactor in step [1] and 81.0 gs of the PDMS having silanol groups at both ends prepared in Synthesis EXAMPLE (2) (manufactured by JNC Corporation, FM9926, weight average molecular weight (Mw)=23,000, distribution index of molecular weight (Mw/Mn)=1.10) was put into said reactor. Further 19.0 gs of ethyl silicate (manufactured by Tama Chemicals Co., Ltd., Silicate 45: linear oligomer which is octomer to decamer, purity: 95% by mass, average molecular weight=1282) and 190 gs of tert-butyl alcohol as a stabilizing solvent were put into said reactor and the contents in said reactor was stirred for 30 minutes at room temperature. Molar ratio of FM9926 to net amount of said oligomer in Silicate 45 was 1:4.

[3] After step [2], 0.01 g of dibutyltin dilaurate was added to obtain raw material solution 2.

[4] The temperature of raw material solution 2 obtained in step [3] was raised from the room temperature to 140° C. at a temperature raising rate of 10° C./min, and then said raw material solution 2 was further heated at 140° C. for one hour after then said raw material solution was naturally cooled to the room temperature to obtain Prepolymer 2.

During said reaction, N₂ gas was always flowed into the reactor.

### Preparation of Sample 2A and 2B For Evaluation by Using Prepolymer 2

[A] The same way as [A] in EXAMPLE 1 was carried out by using Prepolymer 2.

[B] The Prepolymer 2 (sol state) prepared in step [4] was put between two pieces of quartz glass plates keeping a space 0.5 mm so as to form an assembly consisting of quartz glass plate/hybrid material made from prepolymer 2/quartz glass plate. The resulting assembly was heated at 220° C. for 5 hours to cure (gelate) to obtain sample of EXAMPLE 2 as sample for evaluation 2A (cf. FIG. 2).

Further, 10 parts by weight of a curing agent below described was added to 100 parts by weight of Prepolymer 2 (without consideration of the weight of solvent) and the resulting mixture was put between two pieces of quartz glass plates keeping a space 0.5 mm so as to form an assembly. The resulting assembly was heated at 180° C. for 5 hours to cure (gelate) to obtain the other sample of EXAMPLE 2 as sample 2B for evaluation (cf. FIG. 2).

Said curing agent used herein was prepared by mixing 27.2 gs of PDMS [PDMS having silanol groups at both ends (manufactured by JNC Corporation, FM9926], 1.24 gs of a curing catalyst [Zinc octylate (manufactured by Nihon Kagaku Sangyo Co., Ltd., Nikka Octix zinc: 18%)], 1.55 gs of a curing catalyst [Zirconium octylate (manufactured by Nihon Kagaku Sangyo Co., Ltd., Nikka Octix zirconium, Zr: 12%)] and 3.0 gs of solvent (tert-butyl alcohol) and said mixture was put into the other reactor which was not used for preparation of prepolymer and heated at 60° C. and stirred for 30 minutes in the atmosphere.

### COMPARATIVE EXAMPLE 1

### Preparation of the Conventional Prepolymer 1′

[1] The same as step [1] of [EXAMPLE 1] [Preparation of Prepolymer 1 used as the adhesive for UV polarizing film]

[2] 90.0 gs of PDMS having silanol groups at both ends (manufactured by Momentive Performance Materials Inc. XF3905, weight average molecular weight (Mw)=20,000, distribution index of molecular weight (Mw/Mn)=1.5) was put into the reactor in which N₂ gas was filled enough following step [1] of EXAMPLE 1 and further 9.6 gs of Silicate 40 was put into the reactor the same as step [2] of EXAMPLE 1 [Preparation of Prepolymer 1 used as the adhesive for UV polarizing film]. Molar ratio of XF3905 to net amount of said oligomer in Silicate 40 was 1:2.

[3] After step [2] described above, 0.01 g of dibutyltin dilaurate was added as a condensation catalyst and the content in the reactor was heated at 140±5° C. for one hour with agitation to obtain a raw material solution 1′.

[4] Prepolymer 1′ was prepared from above described raw material solution 1′ by the same procedure as step [4] of [EXAMPLE 1] [Preparation of Prepolymer 1 used as the adhesive for UV polarizing film].

### Preparation of Sample 1′ For Evaluation by Using Prepolymer 1′

Sample of COMPARATIVE EXAMPLE 1 as SAMPLE 1′ for evaluation was prepared from Prepolymer 1′ by the same manner as [EXAMPLE 1] [Preparation of Sample 1 For Evaluation by Using Prepolymer 1] [A], [B] (cf. FIG. 2).

### Evaluation 1

### Method for Evaluation

Transmissivity of samples of EXAMPLE 1 (Sample 1 for evaluation), EXAMPLE 2 (Samples 2A, 2B for evaluation), and COMPARATIVE EXAMPLE 1 (Sample 1′ for evaluation) respectively measured in a wavelength range from 200 nm to 800 nm by using the spectrophotometer U-4100 (manufactured by Hitachi Ltd.) and using quartz glass plate having a thickness 0.5 mm as a reference. In this evaluation, transmissivity of only hybrid material was substantially calculated respectively excepting the reflection at the interface since the reflections of the interface between air and the hybrid material, the air and the quartz glass plate, or the like may take place (a physical phenomenon that the light is reflected at the interface between substances having the difference of the refractive index each other).

### The Results of the Evaluation

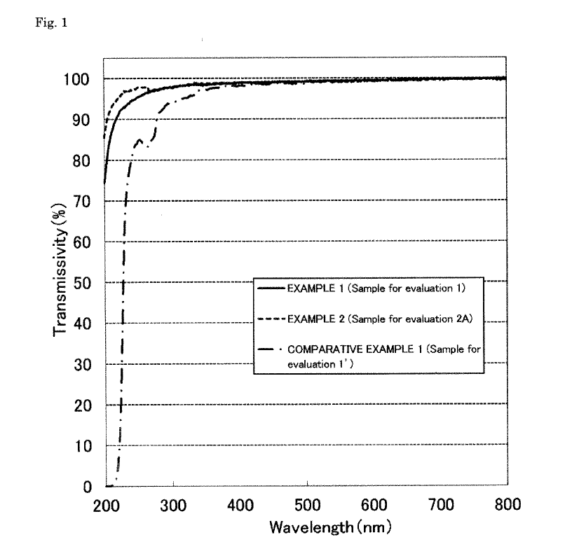

The results of the measurements of the spectral transmissivity of each sample are shown in FIG. 1. Since no difference between sample 2A for evaluation and sample 2B for evaluation is recognized and accordingly, only sample 2A for evaluation as EXAMPLE 2 is shown in FIG. 1.

Referring to Fig, 1, samples of EXAMPLE 1 and EXAMPLE 2 consisting of the hybrid materials of the present invention respectively and sample of COMPARATIVE EXAMPLE 1 consisting of the conventional hybrid material is compared below.

About Sample of EXAMPLE 1, transmissivity at 200 nm is 74% and about sample of EXAMPLE 2, transmissivity at 200 nm is 85%, and at 300 nm, samples of EXAMPLES 1 and 2 have sample transmissivity 98% respectively and at higher wavelength than 300 nm, both samples have transmissivity nearly 100% respectively. Neither difference between presence (Sample 2B) nor absence (Sample 2A) of the curing agent is recognized.

On the other hand, transmissivity of the sample of COMPARATIVE EXAMPLE 1 is 98% at 400 nm, and 94% at 300 nm and absorption peak was observed around 260 nm.

Considering above described results, it was recognized that the hybrid material of the present invention has a high transmissivity and the light can be transmitted homogeneously through the hybrid material as the optical film.

As above described, it is recognized that the hybrid material of EXAMPLE 1 using PDMS having distribution index of molecular weight (Mw/Mn)=1.12 (less than 1.3) and the hybrid material of EXAMPLE 2 using PDMS having distribution index of molecular weight (Mw/Mn)=1.10 (less than 1.3) have superior light transmissivity and transparency than the hybrid material of COMPARATIVE EXAMPLE 1 using PDMS having distribution index (Mw/Mn)=1.5 (more than 1.3).

### EXAMPLE 3

### Preparation of Prepolymer 3 as the Heat-Resistant Sealant

[1] A prepolymer was prepared by the same manner as step [1] in EXAMPLE 1 [preparation of Prepolymer 1 used as the adhesive for UV polarizing film]

[2] 97.4 gs of PDMS silanol groups at both ends prepared in Synthesis EXAMPLE (3) (manufactured by JNC Corporation, FM9927, weight average molecular weight 32,000, Mw/Mn=1.09) was put into the reactor in which N₂ gas was filled enough in step [1], and further 1.5 gs of triethoxyphenylsilane (TEPS: manufactured by Tokyo Chemical Industry Co., Ltd.) as alkoxide having phenyl group was put into said reactor. Molar ratio of FM9927 to TEPS was 1:2.

[3] 0.16 gs of titanium tetra-2-ethylhexoxide (manufactured by Matsumoto Fine Chemical Co., Ltd. TA-30) was further put into the reactor and the resulting mixture was agitated at 80° C. to obtain raw material solution 3.

[4] The temperature of the resulting raw material solution 3 was kept at 80° C. and 1 g of water, necessary amount for hydrolysis process and condensation process, was dropped to the raw material solution 3 for about one hour with agitation to mix.

[5] Further, 5 gs of tert-butyl alcohol as a stabilizing solvent was dropped in the mixture prepared in step [4] with agitation to obtain Prepolymer 3.

### Preparation of Sheet 3 For Evaluation by Using Prepolymer 3

[A] The surface of a mold (15 cm square) was treated with tetrafluoroethylene-perfluoroalkylvinyl ether copolymer (PFA).
[B] Prepolymer 3 sol obtained in step [5] was poured into said mold treated in step [A], so that the thickness of finally obtained sheet became 4 mm, and said prepolymer 3 in said mold was dried and heated to rise the temperature from the room temperature (23° C.) to 180° C. gradually for 2 hours and after then heated at 180° C. for 3 hours.
[C] After heating in step [B], the obtained material was removed from the mold to obtain sample of EXAMPLE 3 as sheet 3 for evaluation. The size of the sheet sample was the length 150 mm×the width 150 mm×the thickness 4 mm.

### COMPARATIVE EXAMPLE 2

### Preparation of the Conventional Prepolymer 2′

[1] The same as step [1] of [EXAMPLE 1] [Preparation of Prepolymer 1 used as the adhesive for UV polarizing film]
[2] 97.4 gs of PDMS having silanol groups at both ends (manufactured by Momentive Performance Materials Inc., YF3057, weight average molecular weight (Mw)=32,000, the distribution index of molecular weight (Mw/Mn)=1.57) was put into the reactor in which N₂ gas was filled enough in step [1] and further, 1.5 gs of triethoxyphenylsilane (TEPS: manufactured by Tokyo Chemical Industry Co., Ltd.) was put into said reactor. Molar ratio of YF3057 to TEPS was 1:2.

[3] 0.16 gs of titanium tetra-2-ethylhexoxide (manufactured by Matsumoto Fine Chemical Co., Ltd. TA-30) was further added to solution prepared in step [2] and the resulting mixture was agitated at 80° C. to obtain raw material solution 2′.

[4] The conventional Prepolymer 2′ was prepared by the same manner as step [4] and step [5] in [EXAMPLE 3] [Preparation of Prepolymer 3 as the heat-resistant sealant].

### Preparation of Sheet 2′ For Evaluation by Using Prepolymer 2′

[A] The mold was treated the same manner as [A] in [EXAMPLE 3] [Preparation of Sheet 3 For Evaluation by Using Prepolymer 3].
[B] Prepolymer 2′ sol obtained in step [5] was poured into said mold prepared in step [A] so that the thickness of finally obtained sheet became 4 mm, and said Prepolymer 2′ in said mold was dried and heated to rise the temperature from the room temperature (23° C.) to 250° C. gradually for 3 hours and after then heated at 250° C. for 5 hours.
[C] Sample of COMPARATIVE EXAMPLE 2 as sheet 2′ for evaluation was obtained by the same manner as step [C] in EXAMPLE 3 [Preparation of sheet 3 for evaluation by using Prepolymer 3]. The size of the sheet sample was the length 150 mm×the width 150 mm×the thickness 4 mm.

### Evaluation 2

### Method for Evaluation

(Evaluation of Mass Measurement)

Evaluation of mass measurement as performed as follows.

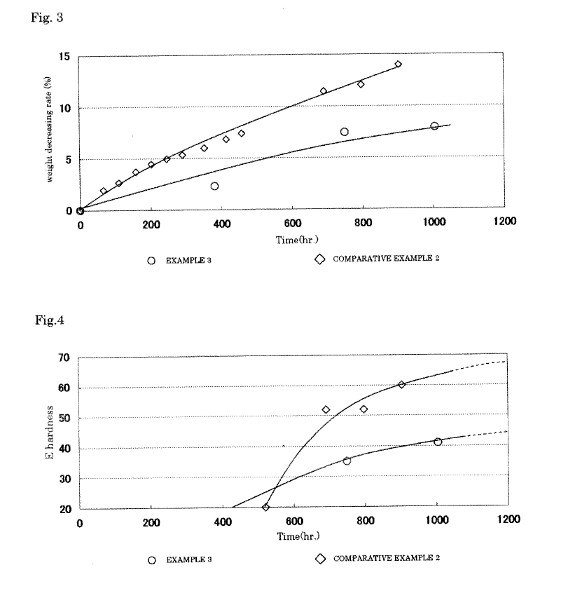

Sample of EXAMPLE 3 and sample of COMPARATIVE EXAMPLE 2 were respectively kept in a convection type drying oven under the environment at 250° C. in the atmosphere and mass (weight) of sample of EXAMPLE 3 and sample of COMPARATIVE EXAMPLE 2 were respectively measured at every designated time until 1000 hours elapsed by using an electronic balance [Mettler-Toledo International Inc., New Classic MF (Model: ML204)] and the rate of change of deceasing mass (weight) for the original mass (weight) (the rate of decrease of mass (weight)) was calculated by the following formula. The rate of change of mass (weight) (%)=(initial mass (weight)−mass (weight) after designated time)/(Initial mass (weight))×100. The results are represented graphically in FIG. 3.

(Evaluation of Hardness Measurement)

Sample of EXAMPLE 3 and sample of COMPARATIVE EXAMPLE 2 were respectively kept in a convection type drying oven under the environment at 250° C. in the atmosphere and hardness of sample of EXAMPLE 3 and sample of COMPARATIVE EXAMPLE 2 were respectively measured at every designated time until 1000 hours elapsed by using a type E durometer for soft rubber use (low hardness) based upon JIS K 6253, ISO 7619 and change of hardness measured about each sample was evaluated. The results are represented graphically in FIG. 4.

### The Results of evaluations

Evaluation of mass measurement is as follows (cf. FIG. 3).

In case of sample of EXAMPLE 3, the mass (weight) decreasing rate gradually increased until 700 hours elapsed under the environment at 250° C. and so the decrease of mass (weight) was a little until 700 hours elapsed. After 700 hours elapsed, the mass (weight) decreasing rate did not substantially change and was about 8% at 1000 hours elapsed, and so said sample showed excellent heat stability.

On the other hand, in case of sample of COMPARATIVE EXAMPLE 2, the mass (weight) decreasing rate increased in a short time until 400 hours elapsed, namely said sample showed a large mass (weight) decrease and the mass (weight) decreasing rate of said sample got over 10% at 700 hours and further, the mass (weight) decreasing rate of said sample continuously increased after 700 hours elapsed.

The condition of the heat treatment for the hybrid material of EXAMPLE 3 relating to the present invention was at 180° C. for 3 hours while the condition of the heat treatment for the hybrid material of COMPARATIVE EXAMPLE 2 was at 250° C. for 5 hours, and therefore the hybrid material of the present invention can be cured at a lower temperature for a shorter time comparing to the hybrid material of COMPARATIVE EXAMPLE 2.

Further, referring to the result of the mass measurement evaluation, decrease of mass (weight) of the hybrid material of EXAMPLE 3 at a high temperature was small, so that the hybrid material of EXAMPLE 3 has a more improved heat resisting property than the hybrid material of COMPARATIVE EXAMPLE 2.

### Evaluation of Hardness Measurement is Below Described (cf. FIG. 4)

Sample of EXAMPLE 3 had a lower hardness than COMPARATIVE EXAMPLE 2 (conventional) sample after keeping under the environment at 250° C. and so hardness of sample of EXAMPLE 3 was substantially in usable range. Further, hardness of sample of EXAMPLE 3 slightly increased even under the environment at 250° C. and even though after 1000 hours elapsed, E-hardness of said sample remained about 40.

On the other side, in the case of sample of COMPARATIVE EXAMPLE 2, hardness of said sample drastically increased between about 500 hours elapse and about 700 hours elapse, and further more increased when 900 hours elapsed.

As the result of hardness measurement evaluation, it was recognized that hybrid material of EXAMPLE 3 of the present invention could maintain lower hardness after keeping at high temperature and had a more improved heat resisting property than hybrid material of COMPARATIVE EXAMPLE 2. Accordingly said hybrid material of the present invention is thermally stable for a long time and can maintain a low hardness longer than 1000 hours at 250° C. and said hybrid material of the present invention has a useful characteristic as heat resistant parts.

Referring to the results above described mass measurement evaluation and above described hardness measurement evaluation, it is recognized that said hybrid material of the present invention has more excellent heat resisting property than the conventional hybrid material.

### Alteration

The present invention should not be limited only by aforementioned EXAMPLES, and alterations, deletions, and additions can be made so far as they don't contradict the technical idea of the present invention which can be recognized by any person skilled in the art from the descriptions of Claims and Specification.

In each EXAMPLE above descried, PDMS having silanol groups at both ends (FM9925 etc.) was respectively used. Nevertheless, PDMS having a silanol group at one end for example PDMS having a silanol group at one end (FM 0925) obtained [Synthesis EXAMPLE relating to synthesis of PDMS having a silanol group at one end] above mentioned may be used in the present invention and the organic-inorganic hybrid prepolymer can be prepared by using said PDMS having a silanol group at one end (such as FM 0925) and further hybrid material of the present invention can be prepared by using said organic-inorganic hybrid prepolymer. In the present invention, hybrid material prepared by using said PDMS having a silanol group at one end also has excellent light transmission property, excellent transparency, and excellent heat-resisting property the same as hybrid material using PDMS having silanol groups at both ends.

Further, in the present invention of course it is not always necessary that only PDMS having silanol groups at both ends or only PDMS having a silanol group at one end is used to prepare hybrid material but both PDMS having silanol groups at both ends and PDMS having a silanol group at one end can be used together.

Metal or semimetal of alkoxide should not be limited to only silicon used in above described EXAMPLES but can be used other kinds of metals or semimetals having different characteristics.

As above described in EXAMPLES, said organic-inorganic hybrid prepolymer in sol state should be cured (gelated) by the drying and firing treatment to obtain the shaped solids or gels and the resulting molded shape of cured prepolymer should not be limited in the present invention. Nevertheless common molded shapes are sheet shape or plate shape.

Purity of inert gas put into the reactor may be higher than 80% and water content of said inert gas may be below 20%.

In a case where said organic-inorganic hybrid material is used as a heat resistant elastic material, a ceramic filler may be combined therein so as to provide thermally conductive property.

Further, in the case of an optical use, wherein a transparent material is required, only said sol may be cured without adding said filler. In the case of an adhesive use, said sol may be provided in a semi-cured state so as to be

cured by the heat treatment during use. Using the present invention, hybrid prepolymer sol being suitable for its specific purpose of usage such as for a sealant, adhesive, thermally conductive sheet, insulating sheet, interlayer insulating film or the like can be provided.

As the application techniques of said organic-inorganic hybrid prepolymer of the present invention, said prepolymer can be adopted for use as an adhesive, paint, or the like, in addition to being useful as a sealant.

The cured material (gelled substance) of said organic-inorganic prepolymer sol of the present invention has a characteristic elasticity at high temperature, and said material also has excellent thermal expansion-shrinkage relaxation ability for the materials to be bonded through the thermal shock. Accordingly, said cured material can be used as an adhesive layer to relax thermal stress by being interposed between different materials to be bonded.

Further, as the application techniques of said organic-inorganic hybrid material, said material can be adopted for use as a sealant or the like, which are adopted for a semiconductive element, such as a luminescent element like a laser diode or the like, and such as a light receiving element like an image sensor or the like.

### POSSIBILITY OF THE INDUSTRIAL USE

Said organic-inorganic hybrid prepolymer of the present invention provides organic-inorganic hybrid material having excellent transparency and heat resisting property, and said material is useful as a sealant or adhesive for heat generating elements, a film or tape used for insulating or for fixing in electronic and electric parts, making the present invention industrially usable.

1. An organic-inorganic hybrid prepolymer produced by the condensation reaction between (A) described below and at least one compound (B) selected from the group consisting of (B-1), (B-2) and (B-3) respectively described below.
(A): A polydimethylsiloxane having silanol group(s) at one end or both ends and having a weight average molecular weight (Mw) in the range of between 3,000 and 100,000 and the distribution index of molecular weight (Mw/Mn, wherein Mn is number average molecular weight) is 1.3 or less (Mw/Mn≦1.3).
(B-1): Metal and/or semimetal alkoxide and/or oligomer of said alkoxide.
(B-2): Complete hydrolysate or partial hydrolysate of (B-1) having alkoxy groups.
(B-3): Condensation product of (B-2) each other or (B-2) and (B-1).

2. The organic-inorganic hybrid prepolymer in accordance with claim 1, wherein said oligomer of said metal and/or semimetal alkoxide is in the range of between dimer and decamer.

3. The organic-inorganic hybrid prepolymer in accordance with claim 1 or 2, wherein said polydimethylsiloxane having silanol group(s) at one end or both ends is a polydimethylsiloxane represented by Chemical formula 1 or Chemical formula 2,
wherein
(a) polydimethylsiloxane having silano groups at both ends
[Chemical formula 1]
HO—Si(CH₃)₂ₗOH (1)
(b) polydimethylsiloxane having a silanol group at one end.
[Chemical formula 2]
HO—Si(CH₃)₂ₗR (2)
wherein in Chemical formula 1 and Chemical formula 2, R is an alkyl group having number of carbon 1 to 4, and l is an integer between 40 to 1351.

4. The organic-inorganic hybrid prepolymer in accordance with any of claims 1 to 3, wherein said metal and/or semimetal alkoxide is represented by a general formula described below.
[Chemical formula 3]
M(OR¹)ₙR²ₘ₋ₙ (3)
wherein in said Chemical formula 3, M is a metal or a semimetal, in is valence number of M, n is an integer between 1 and m, R¹ is an alkyl group having number of carbon 1 to 4 and all R¹ may be the same or differ each other partially or wholly, R² is at least one substituent selected from the group consisting of phenyl group, vinyl group, straight chain alkyl group having number of carbon 1 to 4 and branched alkyl group having number of carbon 3 to 4 and all R² may be the same or differ each other partially or wholly.

5. The organic-inorganic hybrid prepolymer in accordance with claim 4, wherein M in said Chemical formula 3 is at least one metal or semimetal selected from the group consisting of silicon, titanium, zirconium, boron, aluminum and niobium.

6. The organic-inorganic hybrid prepolymer in accordance with any of claims 1 to 3, wherein said metal and/or semimetal oligomer is represented by Chemical formula 4,
wherein
[Chemical formula 4]
R¹OM(OR¹)ₙR²ₘ₋ₙ₋₂OₚR¹ (4)
wherein in above described Chemical formula 4, M is a metal or a semimetal, m is valence number of M, n is an integer between 0 and (m−2), p is an integer between 2 and 10, R¹ is an alkyl group having number of carbon 1 to 4 and all R¹ may be the same or differ each other partially or wholly, R² is at least one substituent selected from the group consisting of phenyl group, vinyl group, straight chain alkyl group having number of carbon 1 to 4 and branched alkyl group having number of carbon 3 to 4 and all R² may be the same or different each other partially or wholly.

7. The organic-inorganic hybrid prepolymer in accordance with claim 6, wherein M in said Chemical formula 4 is at least one metal or semimetal selected from the group consisting of silicon and titanium.

8. An organic-inorganic hybrid material which is a gelled substance produced by heating an organic-inorganic hybrid prepolymer in accordance with any of claims 1 to 7.

9. The organic-inorganic hybrid material in accordance with claim 8, wherein the hardness of said organic-inorganic hybrid material after heating under the circumstances at 250° C. for 1000 hours is 80 or less, wherein the hardness is measured by type E durometer.

10. An element sealing structure, wherein a heat generating element is sealed using said organic-inorganic hybrid material in accordance with claim 8 or claim 9 as a sealant.
